(19) United States
(12) Patent Application Publication
(10) Pub. No.: US 2018/0234160 A1
(43) Pub. Date: Aug. 16, 2018

(54) Demodulation Method and Receiving Device

(71) Applicant: Realtek Semiconductor Corp., HsinChu (TW)

(72) Inventors: Chung-Yao Chang, Hsinchu County (TW); Wei-Chieh Huang, Hsinchu County (TW); Yi-Syun Yang, Kinmen County (TW)

(21) Appl. No.: 15/688,825

(22) Filed: Aug. 28, 2017

(30) Foreign Application Priority Data
Feb. 10, 2017 (TW) 106104325

(51) Int. Cl. H04B 7/08; H04L 27/233

(52) U.S. Cl. CPC H04B 7/0857; H04L 1/0054; H04L 27/2331

(57) ABSTRACT

The present disclosure provides a demodulation method. The demodulation method includes obtaining a received signal; determining whether a multiuser interference is smaller than a threshold; performing a first signal detection operation on the received signal if the multiuser interference is smaller than the threshold, in which the first signal detection operation detects a single layer of spatial data in the received signal; and performing a second signal detection operation on the received signal if the multiuser interference is greater than the threshold, in which the second signal detection operation detects multiple layers of spatial data in the received signal.

### BACKGROUND OF THE INVENTION

### 1. Field of the Invention

The present disclosure relates to a demodulation method and a receiving device, and more particularly, to a demodulation method and a receiving device with low computation complexity.

### 2. Description of the Prior Art

In wireless communication systems, user's demand of high data rate transmission is increasing. Beamforming technology under MIMO (multiple-input-multiple-output) technology may enhance data rate without increasing bandwidth and is attracting more attention. Beamforming technology, combining antenna and DSP (digital signal process) techniques, is able to enhance signal strength in a specific direction and suppress interference from others. Beamforming technology is also able to transmit multiple layers of spatial data, where the multiple layers of spatial data may be only transmitted to a single user or transmitted toward multiple users. However, under a condition that the spatial data is transmitted toward multiple users, one user would not know about the existence of other users. Thus, the receiving device has to perform MLD (Maximum Likelihood Detection) operation. The MLD operation uses exhaustive search to detect the most possible transmitted signal. Nevertheless, to exhaustively search all possibility of multiple users, the MLD operation requires lots of dividers, such that the computation complexity is too large.

Therefore, how to reduce computation complexity is a significant objective in the field.

### SUMMARY OF THE INVENTION

It is therefore a primary objective of the present disclosure to provide a demodulation method and a receiving device with low computation complexity, to improve over disadvantages of the prior art.

The present disclosure provides a demodulation method, applied in a receiving device. The demodulation method includes obtaining a received signal, in which the received signal is corresponding to a signal generated by a transmitting device using a beamforming technology; determining whether a multiuser interference is smaller than a threshold; performing a first signal detection operation on the received signal if the multiuser interference is smaller than the threshold, in which the first signal detection operation detects a single layer of spatial data in the received signal; and performing a second signal detection operation on the received signal if the multiuser interference is greater than the threshold, in which the second signal detection operation detects multiple layers of spatial data in the received signal. The multiuser interference is related to energy of at least an interference signal, and the at least an interference signal comprises a signal which the transmitting device intends to transmit to at least a subscriber other than the receiving device.

The present disclosure further provides a receiving device. The receiving device obtains a received signal and includes a determining unit, a first signal detector and a second signal detector. The determining unit is configured to determine whether a multiuser interference is smaller than a threshold. The first signal detector is configured to perform a first signal detection operation on the received signal, in which the first signal detection operation detects a single layer of spatial data in the received signal. The second signal detector is configured to perform a second signal detection operation on the received signal, in which the second signal detection operation detects multiple layers of spatial data in the received signal. The first signal detector performs the first signal detection operation on the received signal if the multiuser interference is smaller than the threshold, and the second signal detector performs the second signal detection operation on the received signal if the multiuser interference is larger than the threshold. The received signal is corresponding to a signal generated by a transmitting device using a beamforming technology. The multiuser interference is related to energy of at least an interference signal, and the at least an interference signal comprises a signal which the transmitting device transmits to at least a subscriber except the receiving device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a receiving device according to an embodiment of the present disclosure.

FIG. 2 is a schematic diagram of a determining process according to an embodiment of the present disclosure.

### DETAILED DESCRIPTION

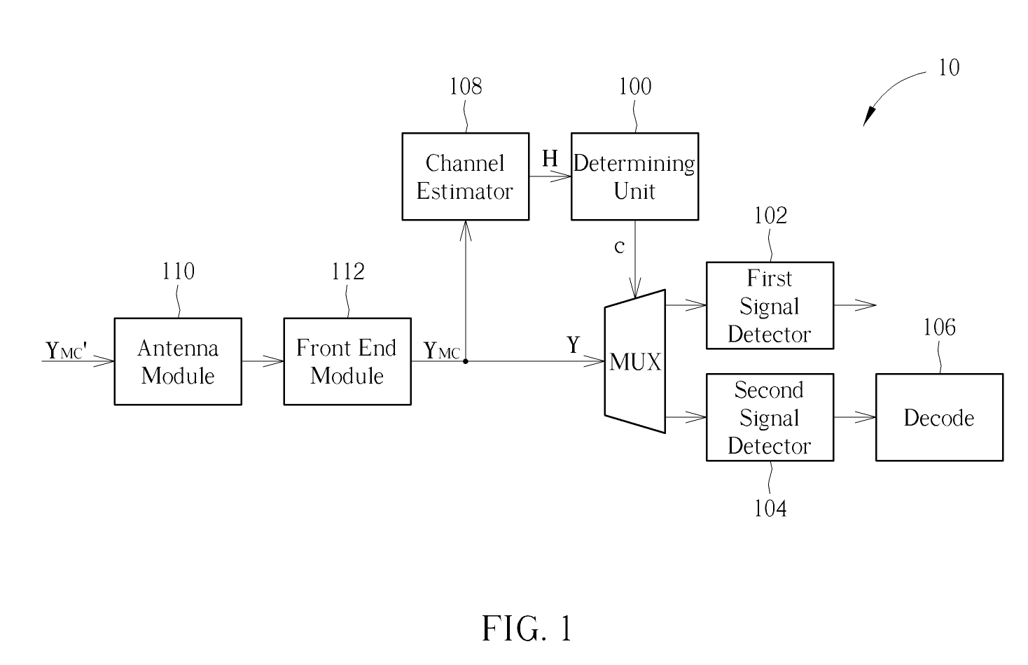

FIG. 1 is a schematic diagram of a receiving device 10 according to an embodiment of the present disclosure. The receiving device 10 maybe a UE (User Equipment) within an LTE (Long-Term Evolution) system or a wireless station within a WLAN (Wireless Local-Area Network), and is a receiving end within a wireless communication system. The receiving device 10 receives a signal S generated by a transmitting device (not illustrated in FIG. 1), where the transmitting device maybe an eNB (Evolved Node B) within the LTE system or another wireless station within the WLAN system. The transmitting device may comprise a plurality of antennas, and the signal S may be a signal generated by OFDM (Orthogonal Frequency Division Multiplexing) and/or beamforming technology.

The signal S transmitted by the transmitting device may comprise a plurality of layers (multi-layers) of spatial data, which is transmitted toward the receiving device 10 and other subscribers other than the receiving device 10. In other words, the multi-layers of spatial data comprise spatial data intended for the receiving device 10 and also spatial data intended for other receiving ends/subscribers from the transmitting device. In general, the receiving device should perform a signal detection operation which is utilized to detect multi-layers spatial data, i.e., MLD (Maximum Likelihood Detection) operation, on the received signal (corresponding to the signal S). However, the signal detection operation utilized for detecting multi-layers spatial data brings large computation complexity and power consumption, and the required circuit area is large as well. To reduce the computation complexity and power consumption of the receiving device 10, the receiving device 10 may determine/evaluate an amount of multiuser interference (MUI). If the MUI is too small, the receiving device 10 may ignore the spatial data which is intended for other receiving ends/subscribers from the transmitting device within the signal S, and simply perform signal detection operation which is utilized for detecting single-layer spatial data, e.g., zero-forcing (ZF) equalization or MRC (Maximum Ratio Combining) operation, so as to reduce the computation complexity, power consumption and the circuit area required.

Specifically, as shown in FIG. 1, the receiving device 10 comprises a determining unit 100, a first signal detector 102, a second signal detector 104, a decoder 106, a channel estimator 108, an antenna module 110 and a front end module 112. The antenna module 110 may comprise a plurality of receiving antennas configured to receive a signal Y_{MC} corresponding to the signal S from the air.

The front end module 112 is configured to perform front signal processing on the signal Y_{MC}′, which is to downconvert the signal Y_{MC}′ to the baseband, convert the baseband signal into digital signal, and perform frequency transformation on the baseband digital signal corresponding to the signal Y_{MC}′, e.g., perform a DFT operation (Discrete Fourier Transform) on the baseband digital signal corresponding to the signal Y_{MC}′, so as to generate the broadband signal Y_{MC}. Note that, the signal Y_{MC} is a multicarrier signal, i.e., the energy thereof is distributed over a plurality of subcarriers.

The channel estimator 108 is coupled to the front end module 112, configured to compute a channel matrix H between the receiving device 10 and the transmitting device corresponding to the k-th subcarrier according to the broadband signal Y_{MC}.

The first signal detector 102 is configured to perform a first signal detection operation on a received signal Y at the k-th subcarrier within the broadband signal Y_{MC}. The first signal detection operation detects only one single layer of spatial data in the received signal Y. For example, the first signal detector 102 may be a ZF equalizer or an MRC detector, and the first signal detection operation is ZF equalization or an MRC operation.

The second signal detector 104 is configured to perform a second signal detection operation on the received signal Y. The second signal detection operation detects multiple layers of spatial data in the received signal Y. For example, the second signal detector 104 may be a maximum likelihood detector, and the second signal detection operation may be an MLD operation. Notably, compared to the first signal detection operation, the second signal detection operation requires more computation complexity, computation power and circuit area.

In addition, the determining unit 100 is coupled to the channel estimator 108, configured to compute a multiuser interference MUI according to the channel matrix H and evaluate an amount of the multiuser interference MUI. When the multiuser interference MUI is great than a threshold Th (which means that the receiving device 10 cannot ignore the spatial data in the signal S intends for other receiving ends/subscribers by the transmitting device), the receiving device 10 unavoidably has to utilize the second signal detector 104 to perform signal detection on the received signal Y. On the other hand, when the multiuser interference MUI is smaller than the threshold Th (which means that the receiving device 10 may ignore the spatial data in the signal S intends for other receiving ends/subscribers), the receiving device 10 may utilize the first signal detector 102 with low computation complexity and computation power to perform signal detection on the received signal Y, so as to reduce the computation complexity and computation power of the receiving device 10.

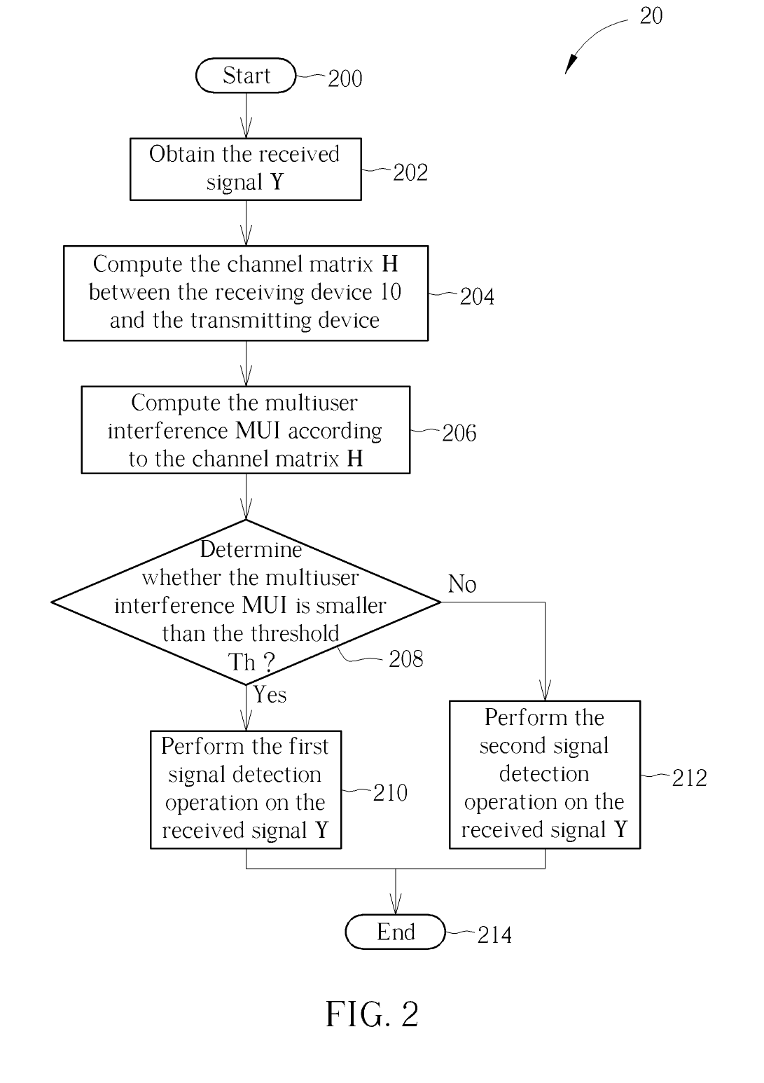

Operations of the receiving device 10 maybe further summarized as a determining process 20. Reference is also made to FIG. 2, which is a schematic diagram of the determining process 20 according to an embodiment of the present disclosure. The determining process 20 is executed by the receiving device 10. As shown in FIG. 2, the determining process 20 comprises the following steps:

Step 200: Start.

Step 202: Obtain the received signal Y.

Step 204: Compute the channel matrix H between the receiving device 10 and the transmitting device.

Step 206: Compute the multiuser interference MUI according to the channel matrix H.

Step 208: Determine whether the multiuser interference MUI is smaller than the threshold Th. If yes, go to Step 210; otherwise, go to Step 212.

Step 210: Perform the first signal detection operation on the received signal Y.

Step 212: Perform the second signal detection operation on the received signal Y.

Step 214: End.

In the determining process 20, Step 202 maybe executed by the antenna module 110 and the front end module 112, Step 204 may be executed by the channel estimator 108, Step 206 may be executed by the determining unit 100, Step 210 may be executed by the first signal detector 102, and Step 212 may be executed by the second signal detector 104.

Specifically, in Step 202, the receiving device 10 may use the antenna module 110 to receive the signal Y_{MC}′ corresponding to the signal S from the air, and utilize the front end module 112 to generate the broadband signal Y_{MC}. That is, the receiving device 10 may obtain the received signal Y at the k-th subcarrier within the broadband signal Y_{MC}.

In Step 204, the channel estimator 108 may extract reference signals on some of the subcarriers from the broadband signal Y_{MC}, perform channel estimation to estimate channels on the subcarriers corresponding to the reference signals, and perform interpolation or extrapolation to compute channel response corresponding to data signals, so as to obtain the channel matrix H (corresponding to the k-th subcarrier). A dimension of the channel matrix H is N_{R}×N_{T}, where N_{R} represents a number of receiving antennas of the antenna module 110, and N_{T} represents a number of transmitting antennas of the transmitting device.

In Step 206, the determining unit 100 computes the multiuser interference MUI according to the channel matrix H. In an embodiment, the determining unit 100 may compute the multiuser interference MUI as interference channel energy corresponding to interference signal within the channel matrix H. Specifically, In an embodiment, under a condition of N_{R}=N_{T}>2, the received signal Y may be expressed as eqn. 1, where W represents noise, x_{I} comprises a plurality of interference signals within the spatial data which the transmitting device intends to transmit to other receiving ends/subscribers, H_{I} represents an interference channel matrix corresponding to the interference signal x_{I}, x_{D} represents a desired signal within the spatial data which the transmitting device intends to transmit to the receiving device 10, and h_{D} represents a channel corresponding to the desired signal x_{D}. In such condition, the determining unit 100 may compute ∥H_{I}∥_{F}² as a measurement of MUI, where ∥H_{I}∥_{F}² is a Frobenius norm of the interference channel matrix H_{I}, which represents the interference channel energy corresponding to the interference channel matrix H_{I}. In addition, under a condition of N_{R}=N_{T}=2, the received signal Y may be expressed as eqn. 2, where x_{I} is an interference signal that the transmitting device intends to transmit to other receiving end/subscriber, h_{I} represents an interference channel corresponding to the interference signal x_{I}. In such a condition, the determining unit 100 may compute the multiuser interference MUI as ∥h_{I}∥₂², which represents the interference channel energy corresponding to the interference channel h_{I}.

$$\begin{matrix}Y = HX + W = [ {H}_{I} {h}_{D} ] [ \begin{matrix}{x}_{I} \\ {x}_{D}\end{matrix} ] + W & ( eqn . 1 ) \\ Y = HX + W = [ {h}_{I} {h}_{D} ] [ \begin{matrix}{x}_{I} \\ {x}_{D}\end{matrix} ] + W & ( eqn . 2 )\end{matrix}$$

In Step 208, the determining unit 100 determines whether the multiuser interference MUI is smaller than the threshold Th, and generates a control signal c according to the determining result. When the determining unit 100 determines that the multiuser interference MUI is smaller than the threshold Th, the determining unit 100 may generate the control signal c to control a multiplexer MUX (of the receiving device 10), such that the received signal Y is delivered to the first signal detector 102. On the other hand, when the determining unit 100 determines that the multiuser interference MUI is greater than the threshold Th, the determining unit 100 may generate the control signal c to control the multiplexer MUX, such that the received signal Y is delivered to the second signal detector 104.

In addition, the multiuser interference MUI is not limited to be the interference channel energy corresponding to the interference signal within the channel matrix. In another embodiment, the determining unit may compute the multiuser interference as an SNR (Signal-to-Noise Ratio) corresponding to the interference signal, i.e., the SNR corresponding to the interference signal may be regarded as another measurement of the multiuser interference. The receiving device may determine whether the interference SNR is smaller than a threshold, and determine to perform either the first signal detection operation or the second signal detection operation on the received signal, which is within the scope of the present invention. In some embodiments, the SNR of the interference signal may be regarded as interference-to-noise ratio.

In Step 210, the first signal detector 102 performs the first signal detection operation on the received signal Y. Since the first signal detection operation detects only one single layer of spatial data in the received signal Y, the first signal detection operation may be a linear operation, and the first signal detector 102 may be a linear detector. In an embodiment, the first signal detector 102 may perform an MRC operation on the received signal Y, i.e., to compute a combination result r as r=h_{D}^{H}Y, and perform demodulation according to the combination result r, where h_{D}^{H} is a conjugate transpose of the channel h_{D} corresponding to the desired signal x_{D}.

In Step 212, the second signal detector 104 performs the second signal detection operation on the received signal Y. In an embodiment, the second signal detector 104 may perform the MLD operation on the received signal Y. Specifically, the second signal detector 104 may obtain the channel matrix H, and perform a QR decomposition on the channel matrix H, so as to obtain an unitary matrix Q and an upper triangular matrix R of the channel matrix H with H=QR. The second signal detector 104 may multiply the received signal Y by the conjugate transpose of the unitary matrix Q, to obtain a transformed received signal Z. The transformed received signal Z may be expressed as Z−Q^{H}Y−Q^{H}(HX+W)−Q^{H}(QR X+W)−RX+W′, where W′−Q^{H}W represents transformed noise. The second signal detector 104 may compute a log-likelihood ratio (LLR) L(bᵢ|Y) corresponding to the i-th bit, according to the transformed received signal Z and the upper triangular matrix R, as

$$L ( {b}_{i} \vert Y ) = {min}_{\tilde{X} ∈ G 1} {‖ Z - R \tilde{X} ‖}^{2} - {min}_{\tilde{X} ∈ G 0} {‖ Z - R \tilde{X} ‖}^{2} ,$$

where \tilde{X} represents a modulated signal generated by the transmitting device according to a modulation scheme, bi represents the i-th bit, G1 represents a set of all possible modulated signals corresponding to the modulation scheme when bi−1, and G0 represents a set of all possible modulated signals corresponding to the modulation scheme when bi=0. In addition,

$${min}_{\tilde{X} ∈ G 1} {‖ Z - R \tilde{X} ‖}^{2}$$

represents a minimum of ∥Z−R\tilde{X}∥² when \tilde{X} ∈ G1, and

$${min}_{\tilde{X} ∈ G 0} {‖ Z - R \tilde{X} ‖}^{2}$$

represents a minimum of ∥Z−R\tilde{X}∥² when \tilde{X} ∈ G0. In addition, after the second signal detector 104 obtains the LLR L(bᵢ|Y), the second signal detector 104 may deliver the LLR L(bᵢ|Y) to the decoder 106, and the decoder 106 may perform a decoding operation according to the LLR L(bᵢ|Y), wherein the decoding operation may be a turbo decoding, and the decoder 106 may be a turbo decoder.

In addition, the second signal detector 104 has to perform a lot of division operations when computing

$${min}_{\tilde{X} ∈ G 1} {‖ Z - R \tilde{X} ‖}^{2} and {min}_{\tilde{X} ∈ G 0} {‖ Z - R \tilde{X} ‖}^{2} .$$

To reduce the computation complexity, in an embodiment, the second signal detector 104 may compute

$${min}_{\tilde{X} ∈ G 1} {‖ Z / {R}_{00} - ( R / {R}_{00} ) \tilde{X} ‖}^{2} and {min}_{\tilde{X} ∈ G 0} {‖ Z / {R}_{00} - ( R / {R}_{00} ) \tilde{X} ‖}^{2}$$

first, and then compute |R₀₀|² times

$${min}_{\tilde{X} ∈ G 1} {‖ Z / {R}_{00} - ( R / {R}_{00} ) \tilde{X} ‖}^{2}$$

and |R₀₀|² times

$${min}_{\tilde{X} ∈ G 0} {‖ Z / {R}_{00} - ( R / {R}_{00} ) \tilde{X} ‖}^{2} ,$$

so as to reduce the computation complexity, wherein R₀₀ represents the (0, 0)th entry of the upper triangular matrix R, i.e., the most top-left entry of the upper triangular matrix R. Specifically, when N_{R}=N_{T}=2,

$${min}_{\tilde{X}} {‖ Z - R \tilde{X} ‖}^{2}$$

is equivalent to eqn. 3. Note that the term Z₁−R₁₁\tilde{X}₁|² in eqn. 3 is greater than zero. For a fixed \tilde{X}₁, the minimum of ∥Z−R\tilde{X}∥² occurs when \tilde{X}₀ satisfies eqn. 4 (where Γ(·) represent a quantization operation). Thus, the second signal detector 104 requires M² times of division operations when computing

$${min}_{\tilde{X}} {‖ Z - R \tilde{X} ‖}^{2}$$

(or eqn. 4), where M represents a modulation order thereof, and computation burden is heavy. In comparison, the second signal detector 104 may compute

$${min}_{\tilde{X}} {‖ Z / {R}_{00} - ( R / {R}_{00} ) \tilde{X} ‖}^{2}$$

first, where

$${min}_{\tilde{X}} {‖ Z / {R}_{00} - ( R / {R}_{00} ) \tilde{X} ‖}^{2}$$

is equivalent to eqn. 5. Similarly, the minimum of ∥Z/R₀₀−(R/R₀₀)\tilde{X}∥² occurs when \tilde{X}₀ satisfies eqn. 6. Since no division operation is required in eqn. 6, and the M² times of division operations required in eqn. 4 are avoided/bypassed, such that the computation complexity and computation power are further reduced.

$$\begin{matrix}\begin{matrix}{min}_{\tilde{X}} {‖ Z - R \tilde{X} ‖}^{2} = {min}_{\tilde{X}} {‖ [ \begin{matrix}{Z}_{0} \\ {Z}_{1}\end{matrix} ] - [ \begin{matrix}{R}_{00} & {R}_{01} \\ 0 & {R}_{11}\end{matrix} ] [ \begin{matrix}{\tilde{X}}_{0} \\ {\tilde{X}}_{1}\end{matrix} ] ‖}^{2} \\ = {min}_{\tilde{X}} [ {\vert {Z}_{0} - {R}_{00} {\tilde{X}}_{0} - {R}_{01} {\tilde{X}}_{1} \vert}^{2} + {\vert {Z}_{1} - {R}_{11} {\tilde{X}}_{1} \vert}^{2} ]\end{matrix} & ( eqn . 3 ) \\ {\tilde{X}}_{0} = Γ ( \frac{{Z}_{0} - {R}_{01} {\tilde{X}}_{1}}{{R}_{00}} ) & ( eqn . 4 ) \\ \begin{matrix}{min}_{\tilde{X}} {‖ Z / {R}_{00} - ( R / {R}_{00} ) \tilde{X} ‖}^{2} = {min}_{\tilde{X}} {‖ \begin{matrix}[ \begin{matrix}{Z}_{0} / {R}_{00} \\ {Z}_{1} / {R}_{00}\end{matrix} ] - \\ [ \begin{matrix}1 & {R}_{01} / {R}_{00} \\ 0 & {R}_{11} / {R}_{00}\end{matrix} ] [ \begin{matrix}{\tilde{X}}_{0} \\ {\tilde{X}}_{1}\end{matrix} ]\end{matrix} ‖}^{2} \\ = {min}_{\tilde{X}} {‖ [ \begin{matrix}{Z}_{0}^{′} \\ {Z}_{1}^{′}\end{matrix} ] - [ \begin{matrix}1 & {R}_{01}^{′} \\ 0 & {R}_{11}^{′}\end{matrix} ] [ \begin{matrix}{\tilde{X}}_{0} \\ {\tilde{X}}_{1}\end{matrix} ] ‖}^{2} \\ = {min}_{\tilde{X}} [ \begin{matrix}{\vert {Z}_{0}^{′} - {\tilde{X}}_{0} - {R}_{01}^{′} {\tilde{X}}_{1} \vert}^{2} + \\ {\vert {Z}_{1}^{′} - {R}_{11}^{′} {\tilde{X}}_{1} \vert}^{2}\end{matrix} ]\end{matrix} & ( eqn . 5 ) \\ {\tilde{X}}_{0} = Γ ( {Z}_{0}^{′} - {R}_{01}^{′} {\tilde{X}}_{1} ) & ( eqn . 6 )\end{matrix}$$

Furthermore, before the receiving device 10 starts to execute the determining process 20, the receiving device 10 may in advance determine whether a number of layer of spatial data, within the signal S (from the transmitting device) to the receiving device 10, is greater than 1. If the receiving device 10 determines that the signal S comprises more than 2 layers of spatial data which is intended for the receiving device 10 by the transmitting device, the receiving device 10 should directly perform the second signal detection operation on the received signal Y, and bypass the determining process 20. In addition, before the receiving device 10 starts to execute the determining process 20, the receiving device 10 may determine whether the signal Y_{MC}′ (received by the front end module 112) is generated by beamforming technology. If yes, then the receiving device 10 starts to execute the determining process 20. The receiving device 10 may perform the determining steps (before the determining process 20) stated in the above according to preamble(s).

In summary, the receiving device of the present invention may determine an MUI between the transmitting device and other receiving ends/subscribers. If the MUI is too small, the receiving device may directly ignore the spatial data intended for the other receiving ends/subscribers, and perform the signal detection operation only for detecting single layer of spatial data, so as to reduce computation complexity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A demodulation method, applied in a receiving device, the demodulation method comprising:
obtaining a received signal, wherein the received signal is corresponding to a signal generated by a transmitting device using a beamforming technology;
determining whether a multiuser interference is smaller than a threshold;
performing a first signal detection operation on the received signal if the multiuser interference is smaller than the threshold, wherein the first signal detection operation detects a single layer of spatial data in the received signal; and
performing a second signal detection operation on the received signal if the multiuser interference is greater than the threshold, wherein the second signal detection operation detects multiple layers of spatial data in the received signal;
wherein the multiuser interference is related to energy of at least an interference signal, and the at least an interference signal comprises a signal which the transmitting device intends to transmit to at least a subscriber other than the receiving device.

2. The demodulation method of claim 1, wherein the step of determining whether the multiuser interference is smaller than the threshold comprises:
computing a channel matrix between the receiving device and the transmitting device; and
computing the multiuser interference according to the channel matrix.

3. The demodulation method of claim 2, wherein the step of computing the multiuser interference according to the channel matrix comprises:
computing the multiuser interference as an energy of at least an interference channel within the channel matrix corresponding to the at least an interference signal.

4. The demodulation method of claim 2, wherein the step of computing the multiuser interference according to the channel matrix comprises:
computing the multiuser interference as a signal-to-noise ratio (SNR) of the at least an interference signal.

5. The demodulation method of claim 1, wherein the first signal detection operation is a zero-forcing (ZF) equalization or a maximum ratio combining (MRC) operation.

6. The demodulation method of claim 1, wherein the second signal detection operation is a maximum likelihood detection (MLD).

7. The demodulation method of claim 6, wherein the step of performing the MLD operation on the received signal comprises:
computing a channel matrix between the receiving device and the transmitting device;
performing a QR decomposition on the channel matrix, to obtain an unitary matrix and an upper triangular matrix of the channel matrix; and
computing a plurality of log-likelihood ratios (LLRs) corresponding to a plurality bits according to the upper triangular matrix.

8. The demodulation method of claim 7, further comprising:
performing a decoding operation according to the plurality of LLRs, to generate a plurality of modulated bits.

9. The demodulation method of claim 7, wherein the step of computing an LLR corresponding to a bit according to the upper triangular matrix comprises:
computing the LLR as
$$L ( {b}_{i} \vert Y ) = {min}_{\tilde{X} ∈ G 1} {‖ Z - R \tilde{X} ‖}^{2} - {min}_{\tilde{X} ∈ G 0} {‖ Z - R \tilde{X} ‖}^{2} ;$$
wherein L(bᵢ|Y) represents the LLR, Y represents the received signal, Z represents a multiplication result of the received signal multiplied by the unitary matrix, R represents the upper triangular matrix, \tilde{X} represents a modulated signal generated by the transmitting device according to a modulation scheme, bᵢ represents the bit, G1 represents a set of all possible modulated signals corresponding to the modulation scheme when the bit is 1, and G0 represents a set of all possible modulated signals corresponding to the modulation scheme when the bit is 0.

10. The demodulation method of claim 9, wherein the step of computing the LLR corresponding to the bit according to the upper triangular matrix comprises:
computing
$${min}_{\tilde{X} ∈ G 1} {‖ Z / {R}_{00} - ( R / {R}_{00} ) \tilde{X} ‖}^{2} and {min}_{\tilde{X} ∈ G 0} {‖ Z / {R}_{00} - ( R / {R}_{00} ) \tilde{X} ‖}^{2} ;$$
wherein R₀₀ represents the (0,0)th entry of the upper triangular matrix.

11. A receiving device, wherein the receiving device obtains a received signal, the receiving device comprising:
a determining unit, configured to determine whether a multiuser interference is smaller than a threshold;
a first signal detector, configured to perform a first signal detection operation on the received signal, wherein the first signal detection operation detects a single layer of spatial data in the received signal; and
a second signal detector, configured to perform a second signal detection operation on the received signal, wherein the second signal detection operation detects multiple layers of spatial data in the received signal;
wherein the first signal detector performs the first signal detection operation on the received signal when the multiuser interference is smaller than the threshold, and the second signal detector performs the second signal detection operation on the received signal when the multiuser interference is larger than the threshold;
wherein the received signal is corresponding to a signal generated by a transmitting device using a beamforming technology;
wherein the multiuser interference is related to energy of at least an interference signal, and the at least an interference signal comprises a signal which the transmitting device intends to transmit to at least a subscriber other than the receiving device.

12. The receiving device of claim 11, further comprising:
a channel estimator, configured to compute a channel matrix between the receiving device and the transmitting device;
wherein the determining unit computes the multiuser interference according to the channel matrix.

13. The receiving device of claim 12, wherein the determining unit computes the multiuser interference as an energy of at least an interference channel within the channel matrix corresponding to the at least an interference signal.

14. The receiving device of claim 11, wherein the determining unit computes the multiuser interference as a signal-to-noise ratio (SNR) of the at least an interference signal.

15. The receiving device of claim 12, wherein the second signal detector is coupled to the channel estimator, configured to perform a QR decomposition on the channel matrix to obtain an unitary matrix and an upper triangular matrix of the channel matrix, and compute a plurality of log-likelihood ratios (LLRs) corresponding to a plurality bits according to the upper triangular matrix.

16. The receiving device of claim 15, further comprising:
a decoder, configured to perform a decoding operation according to the plurality of LLRs.

17. The receiving device of claim 15, wherein the second signal detector computes an LLR corresponding to a bit as
$$L ( {b}_{i} \vert Y ) = {min}_{\tilde{X} ∈ G 1} {‖ Z - R \tilde{X} ‖}^{2} - {min}_{\tilde{X} ∈ G 0} {‖ Z - R \tilde{X} ‖}^{2} ;$$
wherein L(bᵢ|Y) represents the LLR, Y represents the received signal, Z represents a multiplication result of the received signal multiplied by the unitary matrix, R represents the upper triangular matrix, \tilde{X} represents a modulated signal generated by the transmitting device according to a modulation scheme, bᵢ represents the bit, G1 represents a set of all possible modulated signals corresponding to the modulation scheme when the bit is 1, and G0 represents a set of all possible modulated signals corresponding to the modulation scheme when the bit is 0.

18. The receiving device of claim 17, wherein the second signal detector computes
$${min}_{\tilde{X} ∈ G 1} {‖ Z / {R}_{00} - ( R / {R}_{00} ) \tilde{X} ‖}^{2} and {min}_{\tilde{X} ∈ G 0} {‖ Z / {R}_{00} - ( R / {R}_{00} ) \tilde{X} ‖}^{2} ,$$
where R₀₀ represents the (0,0)th entry of the upper triangular matrix.

19. The receiving device of claim 11, wherein the first signal detection operation is a zero-forcing (ZF) equalization or a maximum ratio combining (MRC) operation.

20. The receiving device of claim 11, wherein the second signal detection operation is a maximum likelihood detection (MLD).
